(19) United States
(12) Patent Application Publication
(10) Pub. No.: US 2002/0001370 A1
(43) Pub. Date: Jan. 3, 2002

(54) Voice portal platform

(76) Inventors: David L. Walker, Tucson, AZ (US); Mark G. Mackelprang, Tucson, AZ (US); David V. Elsberry, Tucson, AZ (US); Robert Selph, Tucson, AZ (US)

Correspondence Address: James N. Kallis, Brooks & Kushman P.C., 22nd Floor, 1000 Town Center, Southfield, MI, 48075-1351, US

(21) Appl. No.: 09/874,596

(22) Filed: Jun. 5, 2001

Related U.S. Application Data
(60) Provisional application No. 60/209,509, filed on Jun. 5, 2000.

(51) Int. Cl. H04M 1/64

(52) U.S. Cl. 379/88.04

(57) ABSTRACT

A voice portal platform for communicating content to a telephone user during a telephone call includes a manager for receiving and executing voice application logic of voice applications and for providing a telephone user session having a voice application for the telephone user during the telephone call. A telephony channel provides telephony event signals between the telephone user and the voice application indicative of telephony events. A speech channel provides speech event signals to the voice application and the telephone user in response to speech events from the telephone user and the voice application. A content server provides content event signals by accessing requested content from content sources. The manager maps the voice application logic of the voice application to the telephony channel, the speech channel, and the content server for execution of the voice application logic to generate the event signals during the telephone call.

### CROSS-REFERENCE TO RELATED APPLICATIONS

This application claims the benefit of U.S. Provisional Application No. 60/209,509 filed Jun. 5, 2000.

### TECHNICAL FIELD

The present invention is generally related to communication systems employing voice portal platforms and, more particularly, to a voice portal platform in which the application logic of voice-enabled telephony applications is separated from the underlying voice portal platform elements required to deliver the voice applications to a telephone user.

### BACKGROUND ART

Communication systems having voice portal platforms deliver audio versions of information and content from content data sources to a telephone user. In operation, a telephone user calls a voice portal platform access telephone number and interacts with a voice application provided by the voice portal platform using natural voice commands. The telephone user interacts with the voice application to request a wide variety of content types. The requested content may be in written text and audio formats which are provided to the voice portal platform by content data sources such as the Internet for the telephone user. In the case of the requested content being in a written text format, the voice portal platform converts the written text into an audio version and then forwards the audio version of the requested content to the telephone user via the voice application.

A problem with a typical voice portal platform is that voice application developers are required to understand and deal with the complex technical details of the voice portal platform in order to develop voice applications. Accordingly, what is needed is a voice portal platform configured such that the application logic of voice applications is separated from the underlying voice portal platform elements required to deliver the voice applications to the telephone user. Such a voice portal platform would enable the rapid development and modification of voice applications without changes to the underlying voice portal platform elements thereby allowing voice application developers to focus on the voice applications and not on the technical details of the voice portal platform. Such a voice portal platform would also provide multiple functionally independent voice applications for the telephone user during a telephone user session.

### SUMMARY OF THE INVENTION

Accordingly, it is an object of the present invention to provide a voice portal platform in which the application logic of voice-enabled telephony applications is separated from the voice portal platform elements required to deliver the voice applications to a telephone user.

It is another object of the present invention to provide a voice portal platform in which the application logic of voice applications is separated from the voice portal platform elements required to deliver the voice applications to a telephone user thereby promoting development and modification of the voice applications.

It is a further object of the present invention to provide a voice portal platform in which voice applications are stacked during a telephone user session such that each voice application functions independently of one another.

It is still another object of the present invention to provide a voice portal platform in which voice applications are stacked during a telephone user session such that a command that comes into the voice portal platform is passed through the stacked voice applications until the appropriate voice application processes the command.

It is still a further object of the present invention to provide a voice portal platform in which voice applications are managed independently during a telephone user session.

In carrying out the above objects and other objects, the present invention provides a voice portal platform for communicating content to a telephone user in response to a request for the content from the telephone user during a telephone call. The voice portal platform includes an application/sessions manager operable for receiving and executing voice application logic of at least one voice application. The application/session manager is further operable for providing a telephone user session having at least one voice application for the telephone user during the telephone call. A telephony channel is operable for providing telephony event signals between the telephone user and the at least one voice application of the telephone user session indicative of telephony events between the telephone user and the at least one voice application during the telephone user session. A speech channel is operable for providing speech event signals to the at least one voice application in response to speech events from the telephone user during the telephone user session. The speech channel is further operable for providing speech event signals to the telephone user in response to speech events from the at least one voice application during the telephone user session. A content server is operable for providing content event signals by accessing and locating content requested by the telephone user from content sources. The application/session manager maps the voice application logic of the at least one voice application of the telephone user session to the telephony channel, the speech channel, and the content server for execution of the voice application logic of the at least one voice application in order to generate the telephony event signals, the speech event signals, and the content event signals during the telephone call.

The application/session manager is further operable for stacking at least two voice applications in the telephone user session. The application/session manager switches between the at least two voice applications in response to the telephone user selecting one of the at least two voice applications. The application/session manager maps the voice application logic of the selected one of the at least two voice applications of the telephone user session to the telephony channel, the speech channel, and the content server for execution of the voice application logic of the selected one of the at least two voice applications in order to generate the telephony event signals, the speech event signals, and the content event signals during the telephone call.

The above objects and other objects, features, and advantages of the present invention are readily apparent from the following detailed description of the best mode for carrying out the present invention when taken in connection with the accompanying drawings.

### BRIEF DESCRIPTION OF THE DRAWINGS

FIG. 1 illustrates a block diagram of a communication system having a voice portal platform in accordance with a preferred embodiment of the invention;

FIG. 2 illustrates a block diagram of the voice portal platform within the communication system; and

FIG. 3 illustrates in greater detail the voice portal platform.

### DETAILED DESCRIPTION OF THE PREFERRED EMBODIMENT(S)

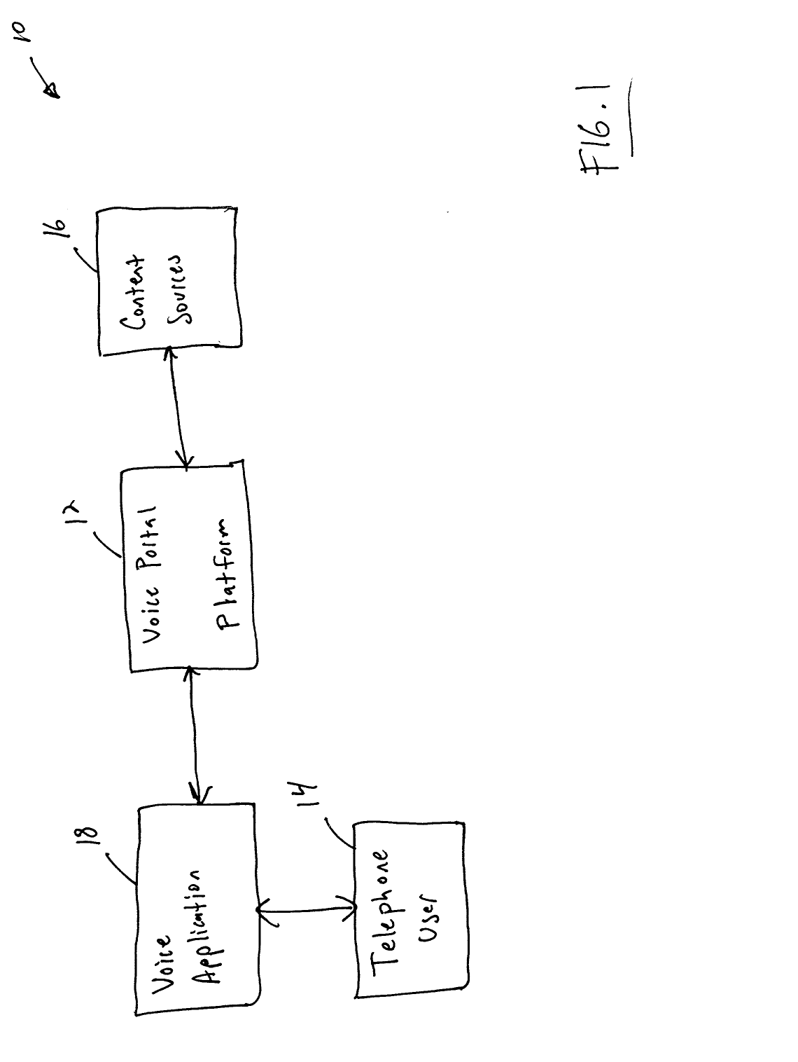

Referring now to FIG. 1, a block diagram of a communication system 10 having a voice portal platform 12 in accordance with a preferred embodiment of the present invention is shown. Voice portal platform 12 enables a telephone user 14 to request and access information, i.e., content, such as written text files and audio files from content sources 16 during a telephone user session. Content sources 16 create various types of content such as email, news stories, weather conditions, sport scores, stock quotes, movie listings, schedules, company reports, driving directions, product prices, horoscopes, and the like. In response to a request for content from telephone user 12 via a voice application 18 provided by voice portal platform 12, the voice portal platform accesses content sources 16 to locate and retrieve the requested content from the content sources. Voice portal platform 12 then provides an audio version of the requested content to voice application 18. In turn, voice application 18 plays the audio version of the requested content to telephone user 12 thereby satisfying the telephone user's request for content.

If the requested content provided by content sources 16 to voice portal platform 12 is in the form of a written text file, then the voice portal platform converts the written text file into an audio file using a text-to-speech (TTS) system. Voice portal platform 12 then provides the audio file to voice application 18 for telephone user 14. If the requested content provided by content sources 16 to voice portal platform 12 is already in the form of an audio file then the voice portal platform directly provides the audio file to voice application 18 for telephone user 14 without any TTS conversion.

Telephone user 14 may be a wired or wireless telephone user. The request for content from telephone user 14 to voice application 18 during a telephone user session may be performed by the telephone user speaking an audible request or using digital signaling such as dual tone multi-frequency (DTMF) touch tone dialing. In response to an audible request from telephone user 14, voice application 18 uses automatic speech recognition capability for understanding the audible request to determine the requested content. Similarly, voice application 18 is functional to understand a DTMF request from telephone user 14 to determine the requested content.

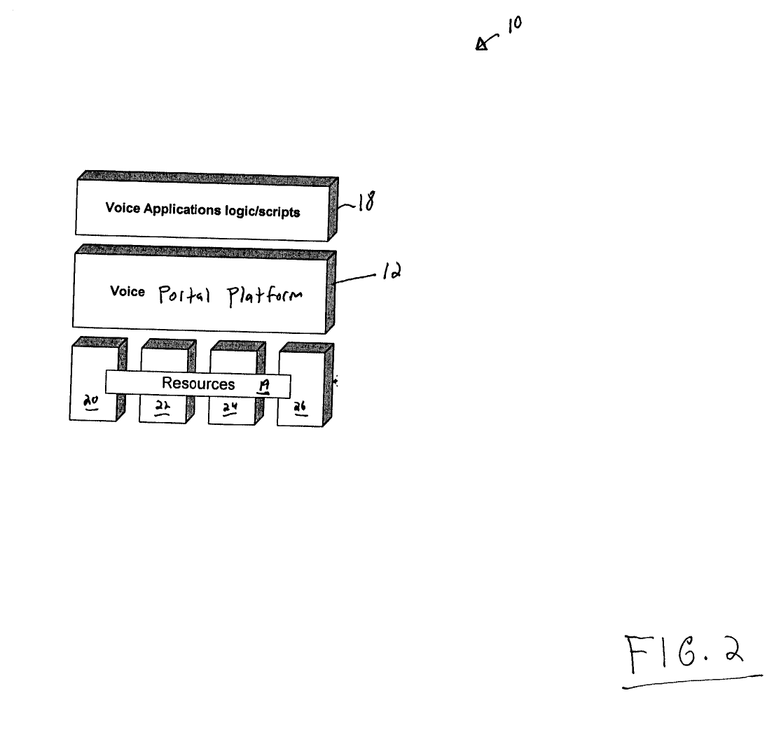

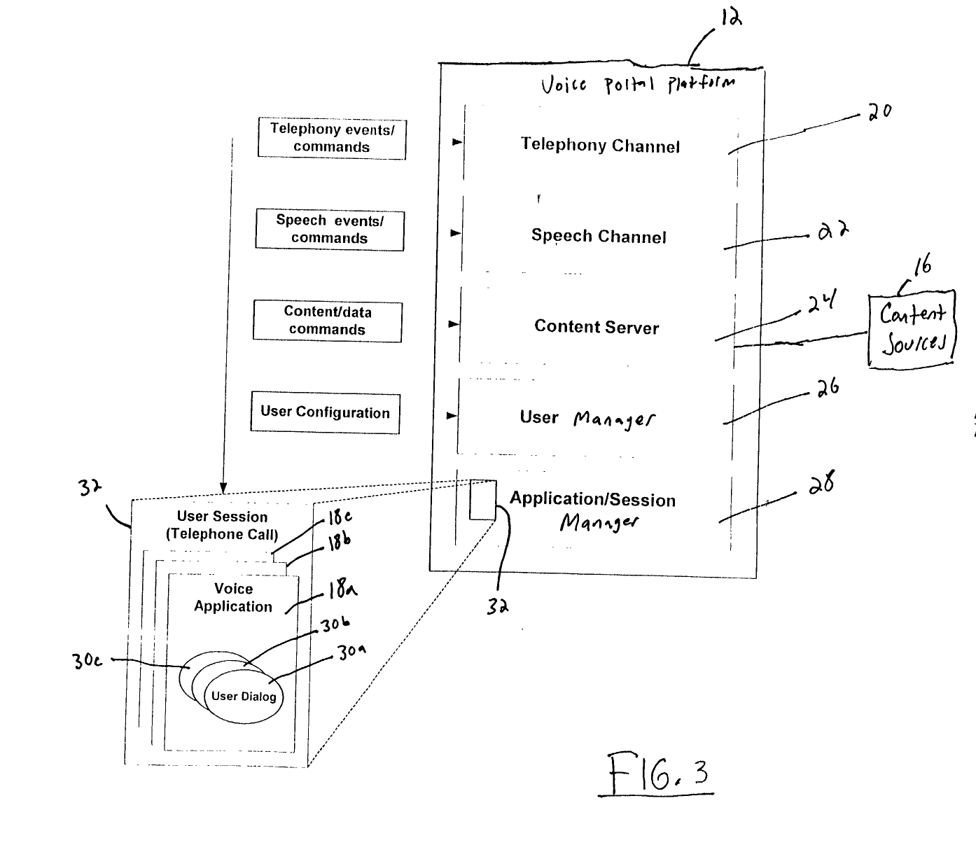

Referring now to FIGS. 2 and 3, a block diagram of voice portal platform 12 within communication system 10 and a detailed block diagram of the voice portal platform are respectively shown. Generally, voice portal platform 12 separates the application logic and scripts of a voice application 18 from the voice portal platform elements or resources 19 required to deliver the voice application to telephone user 14. In effect, voice portal platform 12 shields voice application developers from having to deal directly with voice portal platform resources 19 while developing and modifying voice applications.

The application logic of a voice application 18 is the script that defines how telephone user 14 interaction with the voice application will take place. Basically, the application logic of a voice application 18 is a high level description of what telephone user 14 experiences during a telephone user session with the voice application. This includes such things as the order in which prompts are played, what actions are expected by telephone user 14, how to respond to the expected telephone user actions, the type of content to retrieve, etc.

Resources 19 or voice portal platform elements of voice portal platform 12 required to deliver a voice application 18 to a telephone user 14 include a telephony channel 20, a speech channel 22, a content server 24, a user manager 26, and an application/session manager 28. In operation, application/session manager 28 creates a telephone user session 32 having at least one voice application 18 when telephone user 14 interacts with voice portal platform 12. Application/session manager 28 creates telephone user session 32 the moment telephone user 14 telephones voice portal platform 12 and deletes the telephone user session the moment the telephone user hangs up the telephone call to the voice portal platform. During the life of the telephone call, telephone user session 32 contains one or more functionally independent voice applications 18a, 18b, and 18c for telephone user 14. Telephone user session 32 also keeps track of the complete use of record of telephone user 14 during the telephone call. Application/session manager 28 provides the telephone user record data to user manager 26 for billing and other purposes.

By separating the application logic of a voice application 18 from voice portal platform elements 20, 22, 24, and 26, voice portal platform 12 enables application/session manager 28 to enable multiple functionally independent voice applications 18a, 18b, and 18c to take place during a telephone user session 32. Each voice portal platform element 20, 22, 24, and 26 is operable with application/session manager 28 to service each voice application 18a, 18b, and 18c running during telephone user session 32. In effect, application/session manager 28 is the interface between voice applications 18a, 18b, and 18c and voice portal platform elements 20, 22, 24, and 26. Application/session manager 28 hides all of the technical details of voice portal platform elements 20, 22, 24, and 26 so that voice application developers can create and modify voice applications without addressing the technical details of voice portal platform elements 20, 22, 24, and 26.

A voice application developer creates and modifies a voice application 18 in voice portal platform 12 by 1) defining the call flow, or user dialog 30, the telephone user 18 will experience during a telephone user session 32, and 2) registering content sources 16 with content server 24. User dialog 30 is contained within a voice application 18 and is the basic building block of the flow of a telephone call. Each voice application 18a, 18b, and 18c running during a telephone user session 32 has a corresponding user dialog 30a, 30b, and 30c. Defining a call flow for a voice application 18 includes creating prompts (i.e., “please say the name of a city”), grammars (the list of valid telephone user responses the voice portal platform 12 will respond to), DTMF masks (the related touch tone equivalents for voice commands), and defining the overall application logic of the voice application. In voice portal platform 12, voice applications 18a, 18b, and 18c may be designed by voice application developers who know about voice applications, but who do not know about the technical details of voice portal platform elements 20, 22, 24, 26, and 28.

A voice application developer associates a user dialog 30 with a voice application 18 by plugging the script of the user dialog into application/session manager 28. Application/session manager 28 maps the commands of the script of user dialog 30 for voice application 18 to the appropriate voice portal platform element 20, 22, 24, or 26 in order to execute the voice application during a telephone user session 32.

Each voice portal platform element 20, 22, 24, and 26 is responsible for executing different commands from application/session manager 28 in order to execute a voice application 18 during a telephone user session 32. Telephony channel 20 provides basic telephone call control (i.e., answer, hang up), DTMF management, and prompt management. Telephony channel 20 provides telephony events (i.e., line ringing) to application/session manager 28 for telephone user session 32. Telephony channel 20 hides the telephony hardware from voice application 18 and protects the telephony hardware from changes so that voice application developers do not need. to be concerned with the telephony channel when creating voice applications.

Speech channel 22 provides speech recognition services including static and dynamic grammars, grammar management, grammar activation, and the like. Speech channel 22 provides speech events (i.e., recognition complete) to application/session manager 28 for telephone user session 32. Speech channel 22 hides the speech recognition services from voice application 18 so that voice application developers do not need to be concerned with the speech channel when creating voice applications. For instance, if a different TTS or speech recognition engine is put into the speech recognition services of speech channel 22, the voice application developer does not need to be concerned. Rather, the voice application developer plugs the script of a user dialog 30 of a voice application 18 into application/session manager 28.

User manager 26 puts the telephone user information or configuration (i.e., rights, privileges, per-application information) into a consistent interface for application/session manager 28. Through the interface, a voice application 18 can find a specific telephone user's stock portfolio or how to access the telephone user's email account. As described above, user manager 26 also records the telephone user record data from application/session manager 28 for billing and other purposes.

Content server 24 puts the content types and locations of content sources 16 providing the content into an interface for application/session manager 28. Accordingly, application/session manager 28 can access and manage the content for a voice application 18 consistently.

Registering content-sources 16 with content server 24 is the process of making whatever content is required by a telephone user 14 during a telephone user session 32. For example, a telephone user 14 may want to access traffic reports while commuting. Telephone user 14 then requests voice portal platform 12 via a voice application 18 to provide the desired traffic report. In response to this request for content related to the desired traffic report, voice portal platform 12 locates and accesses the desired traffic report from the appropriate content source 16 and then provides an audio version of the desired traffic report to voice application 18. Voice application 18 then reads the desired traffic report to telephone user 14. This is one example of the many of thousands of types of content telephone user 14 may want to access from voice portal platform 12. This is also one of the many types of voice applications which can interact with telephone user 14 during a telephone user session 32.

Some voice applications such as news readers are read only voice applications. That is, telephone user 14 just listens to the news content being delivered by these voice applications. Other voice applications such as a voice interface to an email system require telephone user 14 interaction. For example, after listening to an email being read by an email voice application, telephone user 14 may want to delete the email. In such a case, a content handler from content server is employed by application/session manager 28 to handle the delete request in the email voice application. Both content server 24 and the content handler are closely related as the content server provides the content and the content handler handles the request for changing the content in some way.

Application/session manager 28 is operable to stack multiple functionally independent voice applications 18a, 18b, and 18c during a telephone user session 32 as a result of the application logic of each voice application being separated from the voice portal platform elements 20, 22, 24, and 26 such that the application/session manager can map the commands of the script of user dialogs 30a, 30b, and 30c of the voice applications to the appropriate voice portal platform element in order to execute the voice applications during the telephone user session. An example of multiple voice applications being stacked during a telephone user session 32 would be a weather reports voice application 18a, a news stories voice application 18b, and a lottery results voice application 18c. Each of these voice applications 18a, 18b, and 18c is a separate voice application.

In operation, when telephone user 14 telephones voice portal platform 12, the telephone user would request content such as a weather report. Speech channel 22 processes the commands from telephone user 14 to determine that the telephone user wants a weather report. In turn, application/session manager 28 would provide weather report voice application 18a in telephone user session 32 for telephone user 14. Speech channel 22 is then executed to determine the desired weather report from telephone user 14. Content server 24 would then access and retrieve the desired weather report from content sources 16 and provide the desired weather report to application/session manager 28. Application/session manager 28 would then have speech channel 22 convert the desired weather report into an audio format (if the weather report is in a text format) and provide the weather report to weather report voice application 18. Weather report voice application 18a then plays the audio version of the desired weather report for telephone user 14.

While listening to the weather report being played by weather report voice application 18a, telephone user 14 may request a news story. Speech channel 22 recognizes the request for a news story. In turn, application/session manager 28 provides news story voice application 18b in addition to weather report voice application 18a in telephone user session 32 for telephone user 14. As before, speech channel 22 is then executed to determine the desired news story and content server 24 retrieves the desired news story from content sources 16. News story voice application 18b would then play the audio version of the desired news story to telephone user 14.

Similarly, while listening to the news story being played by news story voice application 18b, telephone user may request lottery information. In response, application/session manager 28 stacks lottery voice application 18c with weather report voice application 18a and news story voice application 18b in telephone user session 32 for telephone user 14. In effect, each voice application 18a, 18b, and 18c functions independently of each of the other voice applications. Application/session manager 28 is operable to manage each voice application 18a, 18b, and 18c independently by passing events, content, and commands between the appropriate voice portal platform elements 20, 22, 24, and 26 with the appropriate voice applications. Accordingly, application/session manager 28 allows telephone user 14 to hop between different voice applications during a telephone user session 32. This application hopping, the process of going directly from one voice application to another voice application without having to go through a top level manager such as a main menu, differentiates voice portal platform 12 from typical voice portal platforms.

With continual reference to FIG. 3, the following is a step-by-step description of how voice applications are created and executed in voice portal platform 12. Initially, application/session manager 28 sees a line ringing event arrive from telephony channel 20. Application/session manager 28 then creates a telephone user session 32 and adds a default startup voice application such as a login voice application 18 to telephone user session 32. Login voice application 18 then runs its user dialog 30 which plays welcome prompts, sets up the DTMF mask, selects the grammar, and defines the events to watch for and the action to perform when the specified action occurs. User dialog 30 also has the opportunity to call any voice portal platform elements 20, 22, 24, and 26 to perform other desired actions. Such actions include getting content from content server 24, getting user configuration data from user manager 26, starting another voice application, ending the telephone call, and the like.

As events arrive from telephony channel 20 or speech channel 22 they are eventually routed to the currently active user dialog. If the currently active user dialog does not know how to handle that event, the event is passed on to any other voice applications stacked up insider telephone user session 32. Each of those voice applications in turn is given the opportunity to handle the event. The user dialogs run until one of them ends the telephone call. At this point telephone user session 32 is shut down and the usage information is saved by user manager 26.

Thus it is apparent that there has been provided, in accordance with the present invention, a voice portal platform in which the application logic of multiple independently functional voice applications is separated from the voice portal platform elements required to deliver the voice applications to a telephone user that fully satisfies the objects, aims, and advantages set forth above. While the present invention has been described in conjunction with specific embodiments thereof, it is evident that many alternatives, modifications, and variations will be apparent to those skilled in the art in light of the foregoing description. Accordingly, it is intended to embrace all such alternatives.

What is claimed is:

1. A voice portal platform for communicating content to a telephone user in response to a request for the content from the telephone user during a telephone call, the voice portal platform comprising:
an application/sessions manager operable for receiving and executing voice application logic of at least one voice application, the application/session manager further operable for providing a telephone user session having at least one voice application for the telephone user during the telephone call;
a telephony channel operable for providing telephony event signals between the telephone user and the at least one voice application of the telephone user session indicative of telephony events between the telephone user and the at least one voice application during the telephone user session;
a speech channel operable for providing speech event signals to the at least one voice application in response to speech events from the telephone user during the telephone user session, the speech channel further operable for providing speech event signals to the telephone user in response to speech events from the at least one voice application during the telephone user session;
a content server operable for providing content event signals by accessing and locating content requested by the telephone user from content sources;
wherein the application/session manager maps the voice application logic of the at least one voice application of the telephone user session to the telephony channel, the speech channel, and the content server for execution of the voice application logic of the at least one voice application in order to generate the telephony event signals, the speech event signals, and the content event signals during the telephone call.

2. The system of claim 1 wherein:
the application/session manager is further operable for stacking at least two voice applications in the telephone user session, wherein the application/session manager switches between the at least two voice applications in response to the telephone user selecting one of the at least two voice applications.

3. The system of claim 2 wherein:
wherein the application/session manager maps the voice application logic of the selected one of the at least two voice applications of the telephone user session to the telephony channel, the speech channel, and the content server for execution of the voice application logic of the selected one of the at least two voice applications in order to generate the telephony event signals, the speech event signals, and the content event signals during the telephone call.

4. The system of claim 1 further comprising:
a telephone user manager operable for storing data indicative of the generation of the telephony event signals, the speech event signals, and the content event signals during the telephone call.

5. A voice portal platform for communicating content to a telephone user in response to a request for the content from the telephone user during a telephone call, the voice portal platform comprising:
an application/sessions manager operable for receiving and executing voice application logic of at least one voice application, the application/session manager further operable for providing a telephone user session having at least two voice applications for the telephone user during the telephone call, wherein the application/session manager switches between the at least two voice applications in response to the telephone user selecting one of the at least two voice applications;
a telephony channel operable for providing telephony event signals between the telephone user and the at least one voice application of the telephone user session indicative of telephony events between the telephone user and the at least one voice application during the telephone user session;
a speech channel operable for providing speech event signals to the at least one voice application in response to speech events from the telephone user during the telephone user session, the speech channel further operable for providing speech event signals to the telephone user in response to speech events from the at least one voice application during the telephone user session;
a content server operable for providing content event signals by accessing and locating content requested by the telephone user from content sources;
wherein the application/session manager maps the voice application logic of the selected one of the at least two voice applications of the telephone user session to the telephony channel, the speech channel, and the content server for execution of the voice application logic of the selected one of the at least two voice applications in order to generate the telephony event signals, the speech event signals, and the content event signals during the telephone call.
